(19) United States
(12) Patent Application Publication
(10) Pub. No.: US 2024/0175676 A1
(43) Pub. Date: May 30, 2024

(54) POLARIZATION INTERFERENCE PATTERN GENERATION FOR DEPTH SENSING

(71) Applicant: Meta Platforms Technologies, LLC, Menlo Park, CA (US)

(72) Inventors: Yun-Han LEE, Redmond, WA (US); Scott Charles MCELDOWNEY, Redmond, WA (US); Lu LU, Kirkland, WA (US); Mantas ZURAUSKAS, Redmond, WA (US); Qing CHAO, Redmond, WA (US)

(73) Assignee: Meta Platforms Technologies, LLC, Menlo Park, CA (US)

(21) Appl. No.: 18/071,298

(22) Filed: Nov. 29, 2022

(51) Int. Cl. G01B 11/22; G02F 1/01

(52) U.S. Cl. CPC G01B 11/22; G02F 1/0136; G02B 27/283

(57) ABSTRACT

According to examples, a depth sensing apparatus may include an illumination source to output a light beam onto a polarizing beam separation element (PBSE). The PBSE may generate a right hand circularly polarized (RCP) beam and a left hand circularly polarized (LCP) beam to be projected onto a target area, in which the RCP beam and the LCP beam may create an interference with respect to each other. The depth sensing apparatus also includes an imaging component to capture an image of the target area with the RCP beam and the LCP beam projected on the target area, in which the captured image is to be analyzed for depth sensing of the target area. The depth sensing apparatus further includes a polarizer that may increase an intensity of the interference pattern.

### TECHNICAL FIELD

This patent application relates generally to depth sensing apparatuses and specifically to the use of polarizing beam separation elements and polarizers to generate interference patterns that are used to determine depth information of target areas.

### BACKGROUND

With recent advances in technology, prevalence and proliferation of content creation and delivery have increased greatly in recent years. In particular, interactive content such as virtual reality (VR) content, augmented reality (AR) content, mixed reality (MR) content, and content within and associated with a real and/or virtual environment (e.g., a “metaverse”) has become appealing to consumers.

Providing VR, AR, or MR content to users through a wearable device, such as a wearable eyewear, a wearable headset, a head-mountable device, and smartglasses often relies on localizing a position of the wearable device in an environment. The localizing of the wearable device position may include the determination of a three dimensional mapping of the user's surroundings within the environment. In some instances, the user's surroundings may be represented in a virtual environment of the user's surroundings may be overlaid with additional content. Providing VR, AR, or MR content to users may also include tracking users' eyes, such as by tracking a user's gaze, which may include detecting an orientation of an eye in three-dimensional (3D) space.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1A illustrates a diagram of a depth sensing apparatus, according to an example.

FIG. 1B illustrates a diagram of how a polarizer may increase the intensity of an interference pattern, according to an example.

FIG. 2 illustrates a diagram of the depth sensing apparatus depicted in FIG. 1A, according to another example.

FIG. 3 illustrates a portion of a pixelated polarizer that may be used as the polarizer depicted in FIG. 2, according to an example.

FIG. 4 illustrates a metasurface lens that may be used as the polarizer depicted in FIG. 2, according to an example.

FIG. 5 illustrates a diagram of the depth sensing apparatus depicted in FIG. 1A, according to another example.

FIG. 6 illustrates a diagram of the depth sensing apparatus depicted in FIG. 1, according to another example.

FIG. 7 illustrates a diagram of the depth sensing apparatus depicted in FIG. 2, according to another example.

FIG. 8 illustrates a block diagram of a wearable device having components of a depth sensing apparatus, according to an example.

FIG. 9 illustrates a perspective view of a wearable device, such as a near-eye display device, and particularly, a head-mountable display (HMD) device, according to an example.

FIG. 10 illustrates a perspective view of a wearable device, such as a near-eye display, in the form of a pair of smartglasses, glasses, or other similar eyewear, according to an example.

FIG. 11 illustrates a flow diagram of a method for determining depth information of a target area using generated polarization interference patterns, according to an example.

FIG. 12 illustrates a block diagram of a computer-readable medium that has stored thereon computer-readable instructions for determining depth information of a target area using generated polarization interference patterns, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

Fringe projection profilometry is an approach to create depth maps, which may be used to determine shapes of objects and/or distances of objects with respect to a reference location, such as a location of a certain device. In fringe projection profilometry, an illumination source emits a pattern onto an object and a camera captures images of the pattern on the object. The images of the pattern are analyzed to determine the shapes and/or distances of the objects. In order to increase the accuracy of the determined shapes and/or distances, the fringe, e.g., the illuminated pattern, is shifted to multiple positions on the object and images of the pattern at the multiple positions are captured and analyzed. For instance, the fringe may be shifted a fraction or more of the period of the illuminated pattern in each captured image.

In many instances, a mechanical actuator is used to shift the fringe to the multiple positions. The mechanical actuator may be a piezoelectric shifting mechanism that may move the illumination source and/or a grating lens through which light from the illumination source travels. Mechanical actuators, such as piezoelectric shifting mechanisms, may be unsuitable for use in certain types of devices due to the inefficiency and relatively small range of fringe periodicity available through use of the mechanical actuators. Additionally, mechanical actuators often add to the size, expense, and complexity of the devices in which they are used.

Disclosed herein are depth sensing apparatuses that may generate polarized interference patterns that are to be projected onto a target area. The depth sensing apparatuses include at least one imaging component that may capture at least one image of the target area including an interference pattern that is projected onto the target area. The depth sensing apparatuses may also include a controller that may determine depth information of the target area from the at least one captured image. The controller may also determine tracking information of the target area based on the determined depth information. In some examples, the target area may be an eye box of a wearable device, an area around a wearable device, and/or the like. In addition, in some examples, the controller may use the tracking information to determine how images are displayed on the wearable device, e.g., locations of the images, the perceived depths of the images, etc.

The depth sensing apparatuses disclosed herein may include an illumination source, a polarizing beam separation element, and a polarizer. The illumination source may direct a light beam onto the polarizing beam separation element. In addition, the polarizing beam separation element may generate a right hand circularly polarized (RCP) beam and a left hand circularly polarized (LCP) beam to be projected onto a target area, in which an interference between the RCP beam and the LCP beam creates an interference pattern. The polarizer may be positioned to increase an intensity of the interference pattern such as by polarizing the light propagating from the polarizing beam separation element or polarizing the light reflected from the target area. Particularly, for instance, the polarizer may increase the intensity of the interference pattern by allowing light having certain polarizations to pass through the polarizer while blocking light having other polarizations from passing through the polarizer.

In some examples, the polarizer may be a pixelated polarizer, which includes a number of pixel polarizers that have different polarization directions with respect to each other. In these examples, multiple images of the target area and the interference pattern may be captured simultaneously by separating a captured image into the multiple images based on the polarization direction that was applied on the image. That is, images captured by a first set of pixels that captured images that have been polarized by a first pixel polarizer may be grouped into a first image, images captured by a second set of pixels that captured images that have been polarized by a second pixel polarizer may be grouped into a second image, and so forth. In these examples, the fringes of the interference patterns captured in the multiple images may be shifted with respect to each other. The controller may use the multiple images to accurately determine the depth information of the target area without having to perform multiple illumination and image capture operations. This may both reduce a number of operations performed and may enable depth information to be determined even in instances in which the target area is not stationary.

In addition, the use of the pixelated polarizer may enable the multiple images with the shifted fringes to be captured without having to move a polarizer to shift the fringes. In other words, the multiple images with the shifted fringes may be obtained without having to use a mechanical actuator, such as a piezoeletric shifting mechanism. The omission of such a mechanical actuator may enable devices, such as wearable devices, to be fabricated with relatively reduced sizes.

In some examples, the depth sensing apparatuses disclosed herein may include a modulator to modulate the polarization of light emitted through the polarizer. The modulator may include, for instance, a liquid crystal modulator and may be positioned upstream of the polarizer in the direction at which a light beam travels in the depth sensing apparatuses. By modulating the polarization of the light beam as discussed herein, the modulator may cause the fringes in the interference pattern to be shifted. Images of the interference pattern at the shifted positions may be captured and used to determine the depth information of the target area.

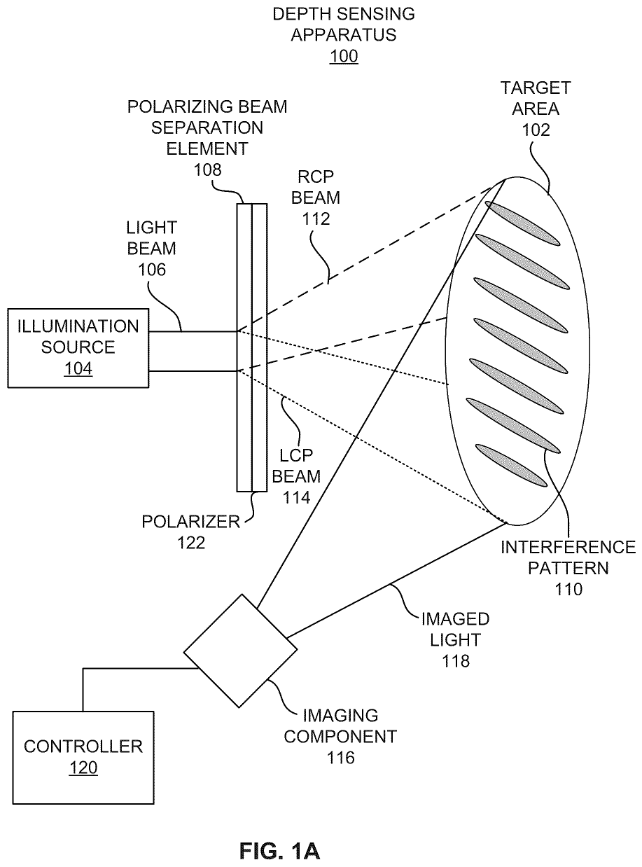

FIG. 1A illustrates a diagram of a depth sensing apparatus 100, according to an example. The depth sensing apparatus 100 may include components for generating polarized interference patterns and for determining depth information of a target area 102 using the polarized interference patterns. In some examples, the depth information may be used to determine tracking information in the target area 102 (e.g., eye tracking, facial tracking, hand tracking, distance tracking, and/or the like). In some examples, the depth sensing apparatus 100 may be included in a wearable device, such as an eyewear device, as discussed in greater detail herein.

The depth sensing apparatus 100 is depicted as including an illumination source 104 that is to output a light beam 106. The illumination source 104 may be, for instance, a vertical cavity surface emitting laser (VCSEL), an edge emitting laser, a tunable laser, a source that emits coherent light, a combination thereof, or the like. In some examples, the illumination source 104 is configured to emit light within an infrared (IR) band (e.g., 780 nm to 2500 nm). In some examples, the illumination source 104 may output the light beam 106 as a linearly polarized light beam 106.

The depth sensing apparatus 100 may also include a polarizing beam separation element 108 that is to diffract the light beam 106 and cause an interference pattern 110 to be projected onto the target area 102. Particularly, for instance, the polarizing beam separation element 108 may generate a right hand circularly polarized (RCP) beam 112 and a left hand circularly polarized (LCP) beam 114 from the light beam 106. As shown in FIG. 1, the RCP beam 112 and the LCP beam 114 are diverging from each other such that, for instance, the RCP beam 112 and the LCP beam 114 may overlap and interfere with each other to form the interference pattern 110. The interference pattern 110 may be an arrangement of fringes or bands that may be created due to the interference of the RCP beam 112 and the LCP beam 114. In addition, the fringes in the interference pattern 110 may be distorted due to contours in the target area 102.

According to examples, the polarizing beam separation element 108 is a Pancharatnam-Berry-Phase (PBP) grating. In some examples, the PBP grating is a PBP liquid crystal grating. In these examples, the PBP grating may be an active PBP liquid crystal grating (also referred to as an active element) or a passive PBP liquid crystal grating (also referred to as a passive element). An active PBP liquid crystal grating may have two optical states (i.e., diffractive and neutral). The diffractive state may cause the active PBP liquid crystal grating to diffract light into a first beam and a second beam that each have different polarizations, e.g., RCP and LCP. The diffractive state may include an additive state and a subtractive state. The additive state may cause the active PBP liquid crystal grating to diffract light at a particular wavelength to a positive angle (+θ). The subtractive state may cause the active PBP liquid crystal grating to diffract light at the particular wavelength to a negative angle (−θ). The neutral state may not cause any diffraction of light (and may not affect the polarization of light passing through the active PBP liquid crystal grating). The state of an active PBP liquid crystal grating may be determined by a handedness of polarization of light incident on the active PBP liquid crystal grating and an applied voltage.

An active PBP liquid crystal grating may operate in a subtractive state responsive to incident light with a right handed circular polarization and an applied voltage of zero (or more generally below some minimal value), may operate in an additive state responsive to incident light with a left handed circular polarization and the applied voltage of zero (or more generally below some minimal value), and may operate in a neutral state (regardless of polarization) responsive to an applied voltage larger than a threshold voltage, which may align the liquid crystal with positive dielectric anisotropy along with the electric field direction. If the active PBP liquid crystal grating is in the additive or subtractive state, light output from the active PBP liquid crystal grating may have a handedness opposite that of the light input into the active PBP liquid crystal grating. In contrast, if the active PBP liquid crystal grating is in the neutral state, light output from the active PBP liquid crystal grating may have the same handedness as the light input into the active PBP liquid crystal grating.

In some examples, the PBP liquid crystal grating is a passive element. A passive PBP liquid crystal grating may have an additive optical state and a subtractive optical state, but may not have a neutral optical state. As an incident beam passes through the passive PBP liquid crystal grating, any left circularly polarized part of the beam may become right circularly polarized and may diffract in one direction (+1^{st} diffraction order), while any right circularly polarized part may become left circularly polarized and may diffract in the other direction (−1^{st} diffraction order).

In other examples, the polarizing beam separation element 108 may be a polarization selective grating, e.g., a hologram that may achieve a similar function to a PBP grating, a birefringent prism, a metamaterial, and/or the like. The birefringent prism may be made with birefringent material, such as calcite.

The depth sensing apparatus 100 may further include an imaging component 116 that may capture at least one image of the target area 102 and the interference pattern 110 reflected from the target area 102, e.g., the imaged light 118. The imaging component 116 may be or may include an imaging device that captures the at least one image. For instance, the imaging component 116 may include a charge-coupled device (CCD), a complementary metal-oxide-semiconductor (CMOS) device, or the like. The imaging device may be, e.g., a detector array of CCD or CMOS pixels, a camera or a video camera, another device configured to capture light, capture light in a visible band (e.g., ˜380 nm-700 nm), capture light in the infrared band (e.g., 780 nm to 2500 nm), or the like. In some examples, the imaging device may include optical filters to filter for light of the same optical band/sub-band and/or polarization of the interference pattern 110 that is being projected onto the target area 102.

According to examples, the depth sensing apparatus 100 may include a controller 120 that may determine depth information of the target area 102 using the at least one captured image. In some examples, the controller 120 may also determine the tracking information from the determined depth information. In some examples, the controller 120 may control the illumination source 104 to output the light beam 106 and the imaging component 116 to capture the at least one image of the target area 102 and the interference pattern 110. The controller 120 may also control the imaging component 116 to capture at least one image of the target area 102 when the target area 102 is not illuminated with an interference pattern 110. The controller 120 may be a semiconductor-based microprocessor, a central processing unit (CPU), an application-specific integrated circuit (ASIC), a field-programmable gate array (FPGA), and/or other hardware device.

The controller 120 may determine the depth information by, for instance, measuring distortion (e.g., via triangulation) of the interference pattern 110 over the target area 102. Alternatively, the controller 120 may determine the depth information using Fourier profilometry or phase shifting profilometry methods. If more than one imaging component 118 is used, the controller 120 may use the interference pattern 110 as a source of additional features to increase robustness of stereo imaging. As another example, the controller 120 may apply machine learning to estimate the 3D depth of an illuminated object of interest. In this example, the controller 120 may have been trained using learning data and may have performed testing of a data set to build a robust and efficient machine learning pipeline.

In some examples, the controller 120 may also determine tracking information from the determined depth information. By way of example, in instances in which the target area 102 includes an eye box of a wearable device, the controller 120 may determine tracking information for a user's eye and/or portions of the user's face surrounding the eye using the depth information. In some examples, the tracking information describes a position of the user's eye and/or the portions of the face surrounding the user's eye.

The controller 120 may estimate a position of the user's eye using the one or more captured images to determine tracking information. In some examples, the controller 120 may also estimate positions of portions of the user's face surrounding the eye using the one or more captured images to determine tracking information. It should be understood that the tracking information may be determined from depth information using any suitable technique, e.g., based on mapping portions of the one or more captured images to a 3D portion of an iris of the user's eye to find a normal vector of the user's eye. By doing this for both eyes, the gaze direction of the user may be estimated in real time based on the one or more captured images. The controller 120 may then update a model of the user's eye and/or the portions of the face surrounding the user's eye.

In other examples, in instances in which the target area 102 includes an area outside of a wearable device, e.g., in front of the wearable device, the controller 120 may determine tracking information for at least one object in the target area 102 using the depth information. The controller 120 may estimate the position(s) of the object(s) using the one or more captured images to determine the tracking information in similar manners to those discussed above.

The depth sensing apparatus 100 may also include a polarizer 122 positioned along a path of the light beam 106 between the polarizing beam separation element 108 and the imaging component 116. The polarizer 122 may be an optical filter that allows light waves of a specific polarization to pass through the filter while blocking light waves of other polarizations. The polarizer 122 may increase the intensity of the interference pattern 110 such that the imaging component 116 may more readily capture an image of the interference pattern 110. For instance, the polarizer 122 may block light with one polarization, but may allow light with an orthogonal polarization, such that an intensity fringe is formed on the interference pattern 110.

An example of how the polarizer 122 may increase the intensity of the interference pattern 110 is depicted in FIG. 1B. Particularly, FIG. 1B illustrates a diagram 150 of an example of the polarization directions 152 of light 154 that has propagated through the polarizing beam separation element 108. The diagram 150 also shows that the light 154 may propagate through the polarizer 122, which may transmit vertically polarized light as denoted by the arrow 158. As a result, the polarizer 122 may allow vertically polarized light to pass through the polarizer 122 and to partially block diagonally polarized light, depending upon the magnitudes of the orientations of the light. The resulting light 160 may thus include fringes 162 having different intensities as represented by the sizes of the arrows and the shadings.

In the example shown in FIG. 1A, the polarizer 122 is positioned adjacent to the polarizing beam separation element 108 such that the polarizer 122 may polarize the RCP beam 112 and the LCP beam 114 prior to the RCP beam 112 and the LCP beam 114 being projected onto the target area 102. In other words, the polarizer 122 may increase the intensity of the interference pattern 110 generated by the interference between the RCP beam 112 and the LCP beam 114 prior to the interference pattern 110 being projected onto the target area 102.

The polarizer 122 may be positioned adjacent to, e.g., in contact with the polarizing beam separation element 108. In other examples, a gap may be provided between the polarizing beam separation element 108 and the polarizer 122.

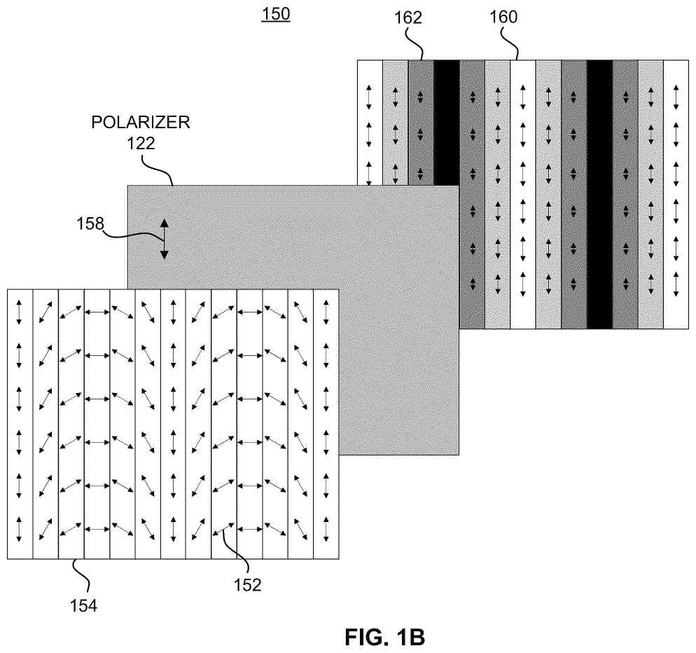

Turning now to FIG. 2, there is illustrated a diagram of the depth sensing apparatus 100 depicted in FIG. 1A, according to another example. In FIG. 2, the depth sensing apparatus 100 is depicted as including a polarizer 124 that is positioned between the target area 102 and the imaging component 116. In some examples, the polarizer 124 may be positioned adjacent to the imaging component 116, either as a separate filter from the imaging component 116 or as a filter within the imaging component 116. In any regard, the polarizer 124 may increase an intensity of the interference pattern 110, e.g., to generate an enhanced interference pattern 126 for the imaging component 116 to image. That is, the polarizer 124 may increase an intensity of the interference pattern 110 that the imaging component 116 may capture as an image.

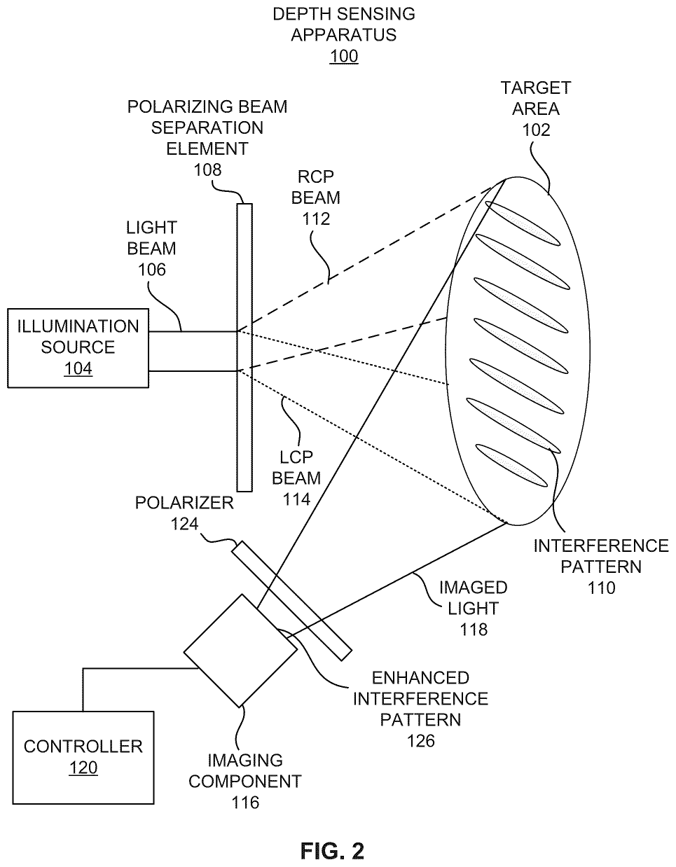

In some examples, the polarizer 124 is a pixelated polarizer 200, an example of which is shown in FIG. 3. Particularly, FIG. 3 illustrates a portion of a pixelated polarizer 200 that may be used as the polarizer 124 depicted in FIG. 2, according to an example. The pixelated polarizer 200 is depicted as including four pixel polarizers 202-208, in which each of the pixel polarizers 202-208 is positioned in front of a corresponding pixel 210 of the imaging component 116. The pixels 210 of the imaging component 116 may each be a CCD pixel, a CMOS pixel, or the like. In this regard, the pixel polarizers 202-208 may each have dimensions that are around 5.0 microns and about 10 microns.

As shown in FIG. 3, each of the pixel polarizers 202-208 may have a different polarization direction with respect to each other. By way of non-limiting example, a first pixel polarizer 202 may have a polarization direction of 0°, a second pixel polarizer 204 may have a polarization direction of 45°, a third pixel polarizer 206 may have a polarization direction of 90°, and a fourth pixel polarizer 208 may have a polarization direction of −45°. As a result, each of the pixel polarizers 202-208 may apply a different polarization direction to the imaged light 118 directed onto the pixels 210. The imaging component 116 may thus simultaneously capture multiple images in which the fringes in the interference pattern 110, e.g., the periods of the fringes, have been shifted. In this regard, the controller 120 may accurately determine the depth information of the target area 102 using multiple images captured through a reduced number of, e.g., a single, illumination and image capture operation.

Although four pixel polarizers 202-208 are shown in FIG. 3, it should be understood that the pixelated polarizer 200 may include any number of pixel polarizers 202-208 having various polarization directions with respect to each other. Likewise, the imaging component 116 may include any number of pixels 210. In addition, the pixelated polarizer 200 may be arranged to include arrays of the pixel polarizers 202-208 such that, for instance, the arrangement of the pixel polarizers 202-208 as depicted in FIG. 3 may be repeated across the pixelated polarizer 200.

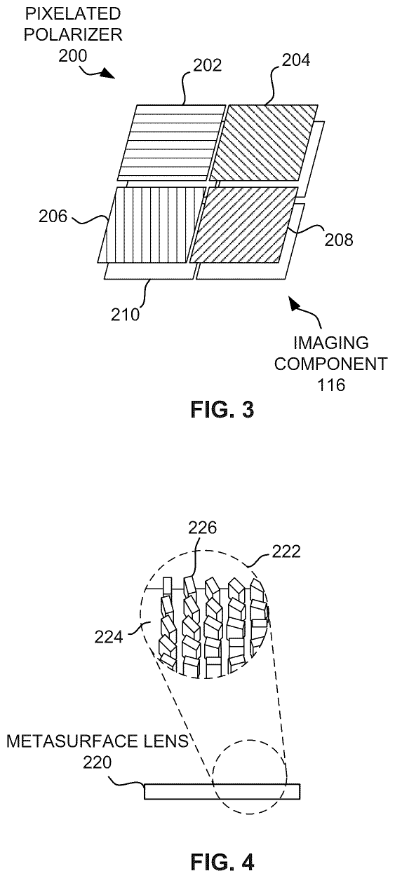

In some examples, the polarizer 124 may be a metasurface lens 220 as shown in FIG. 4. Particularly, FIG. 4 illustrates a metasurface lens 220 that may be used as the polarizer 124 depicted in FIG. 2, according to an example. The metasurface lens 220 may introduce a phase shift in an incident wavefront to allow for control of the deflection of light rays. The metasurface lens 220 may include components arranged to introduce the phase shift and enable the metasurface lens 220 to serve both as an infrared (IR) filter and a polarizer.

FIG. 4 also illustrates a detail 222 of an example metasurface lens 220 that includes a pattern of structures 226 arranged on a surface 224 of the metasurface lens 220. The structures 226 may be nanometer-scale structures, e.g., nano-structures. In some examples, the metasurface lens 220 may be formed of a material or a combination of materials that have appropriate optical properties to facilitate light propagation. For instance, the metasurface lens 220 may be formed of glass, silicon dioxide, titanium dioxide (TiO2), and/or the like. The metasurface lens 220 may also be formed of other material nanobricks or pillars with different orientations deposited on a substrate. In some examples, instead of extending above the surface 224, the structures 226 may be arranged within, e.g., etched, into a substrate of the metasurface lens 220. In other examples, the metasurface lens 220 may be created in a material such as glass or polymer using sub-surface laser writing to create refractive index modulation. In some examples, the metasurface lens 220 may, in addition to acting as lens, be designed to act as color filter. In some examples, compared with traditional wiregrids, the light efficiency of the metasurface lens 220 may reach up to 100% in theory for polarized input light if designed properly.

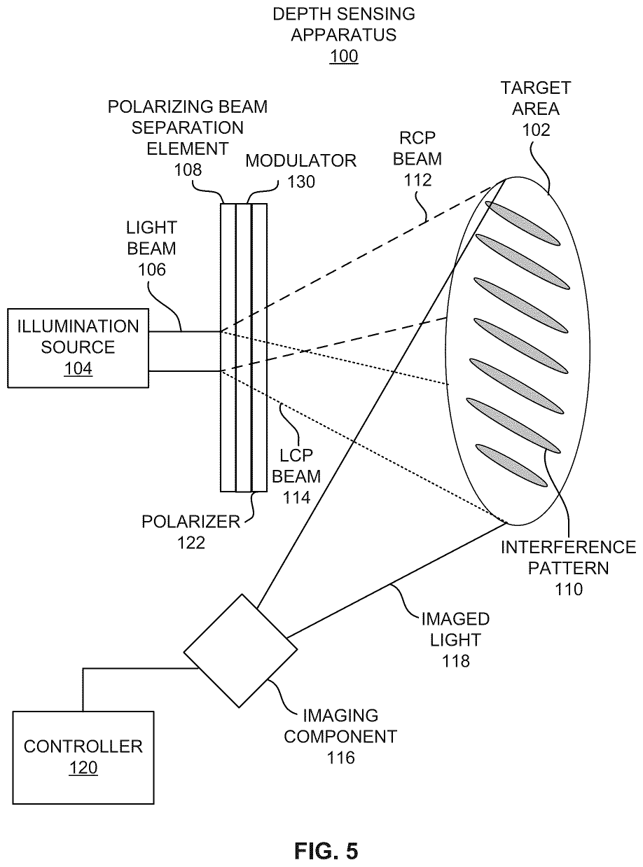

With reference now to FIG. 5, there is illustrated a diagram of the depth sensing apparatus 100 depicted in FIG. 1, according to another example. In FIG. 5, the depth sensing apparatus 100 is depicted as also including a modulator 130 that is to shift a period of the interference pattern 110. Shifting of the period of the interference pattern 110 may cause the fringes in the interference pattern 110 to be shifted by a fraction of the period of the interference pattern 110. That is, the period of the interference pattern 110 may be the time that it takes for successive crests in the fringes of the interference pattern 110 to pass a specified point. Shifting of the period may thus include, shifting of the time that it takes for successive crests in the fringes of the interference pattern 110 to pass the specified point.

In some examples, the modulator 130 may be a liquid crystal modulator while in other examples, the modulator 130 may be another type of modulator. The modulator 130 may also be a mechanical polarization switch, an electro-optical crystal polarization switch, e.g., a Lithium Niobate crystal, or the like. In addition, in the example shown in FIG. 5, the modulator 130 is shown as being positioned between the polarizing beam separation element 108 and the polarizer 122.

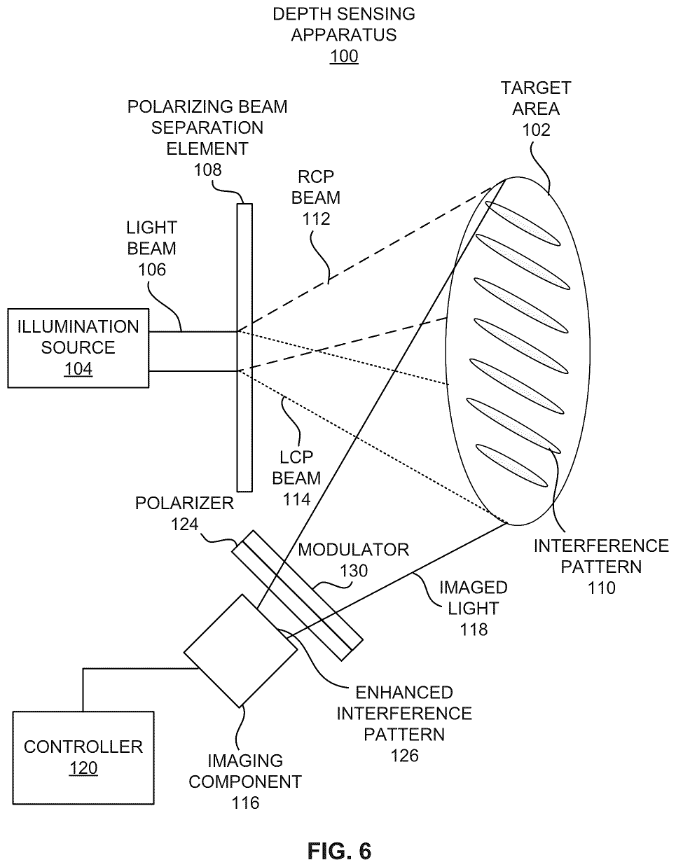

In other examples, such as in the example shown in FIG. 6, the modulator 130 may be positioned between the target area 102 and the polarizer 124. For instance, the modulator 130 may be positioned adjacent to the polarizer 124 opposite the side at which the imaging component 116 is located with respect to the polarizer 124. In the example shown in FIG. 6, the modulator 130 may shift a period of the interference pattern 110 directed onto the imaging component 116. Shifting of the period of the interference pattern 110 may cause the fringes in the interference pattern 110 to be shifted by a fraction of the period.

In the examples shown in FIGS. 5 and 6, the imaging component 116 may capture multiple images of the target area 102 with the interference pattern 110 shifted at multiple fractions of a period of the interference pattern 110. By way of example, the interference pattern 110 may be shifted three or more times and three or more images of the target area 102 with the shifted interference pattern 110 may be captured. In addition, the controller 120 may use the multiple captured images to determine the depth information, in which the additional captured images may increase the accuracy of the depth information, e.g., by providing increased resolution to the depth information.

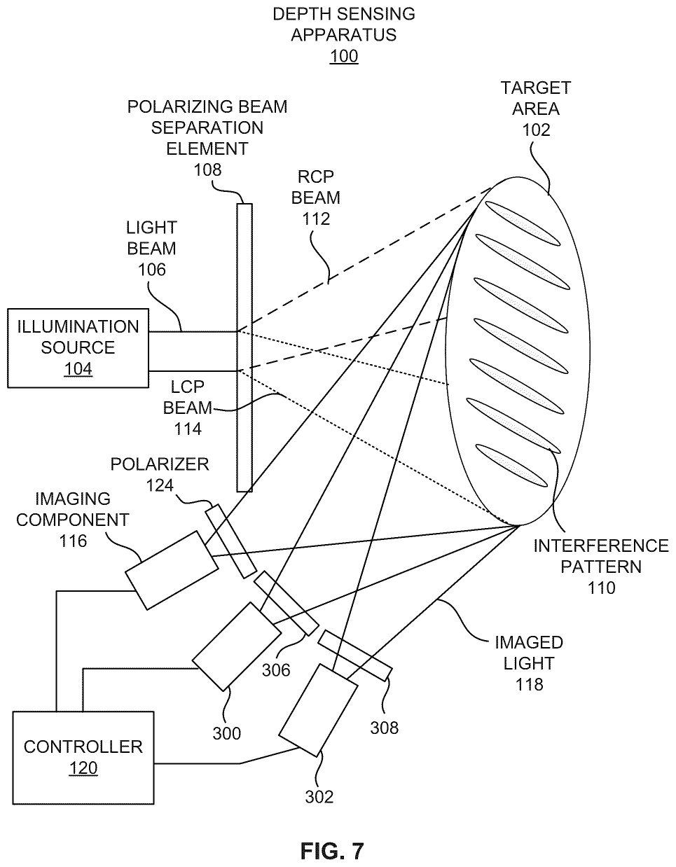

Turning now to FIG. 7, there is illustrated a diagram of the depth sensing apparatus 100 depicted in FIG. 2, according to another example. As shown in FIG. 7, the depth sensing apparatus 100 may include multiple imaging components 116, 300, 302. Particularly, the depth sensing apparatus 100 may include a second imaging component 300 that is positioned to capture a second image of the target area 102. The depth sensing apparatus 100 may also include a third imaging component 302 that is positioned to capture a third image of the target area 102. The second and third imaging components 300, 302 may be similar to the imaging component 116.

The depth sensing apparatus 100 is also depicted in FIG. 7 as including a plurality of polarizers 124, 306, and 308. Particularly, the depth sensing apparatus 100 may include a second polarizer 306 that is positioned to generate a second interference pattern to be captured by the second imaging component 300. The depth sensing apparatus 100 may also include a third polarizer 308 that is positioned to generate a third interference pattern to be captured by the third imaging component 302. The second polarizer 306 and the third polarizer 308 may generate the second and third interference patterns to respectively be captured by the second and third imaging components 300, 302 by increasing the intensities of the second and third interference patterns.

According to examples, each of the polarizers 124, 306, and 308 may apply a different polarization direction to the imaged light 118 directed onto the imaging components 116, 300, and 302. By way of non-limiting example, the polarizer 124 may have a polarization direction of 0°, the second polarizer 306 may have a polarization direction of 30°, and the third polarizer 308 may have a polarization direction of 60°. As a result, the imaging components 116, 300, and 302 may simultaneously capture multiple images of the target area 102 in which the fringes in the interference patterns have been shifted. In this regard, the controller 120 may accurately determine the depth information of the target area 102 through a reduced number of illumination and image capture operations, e.g., a single illumination and image capture operation.

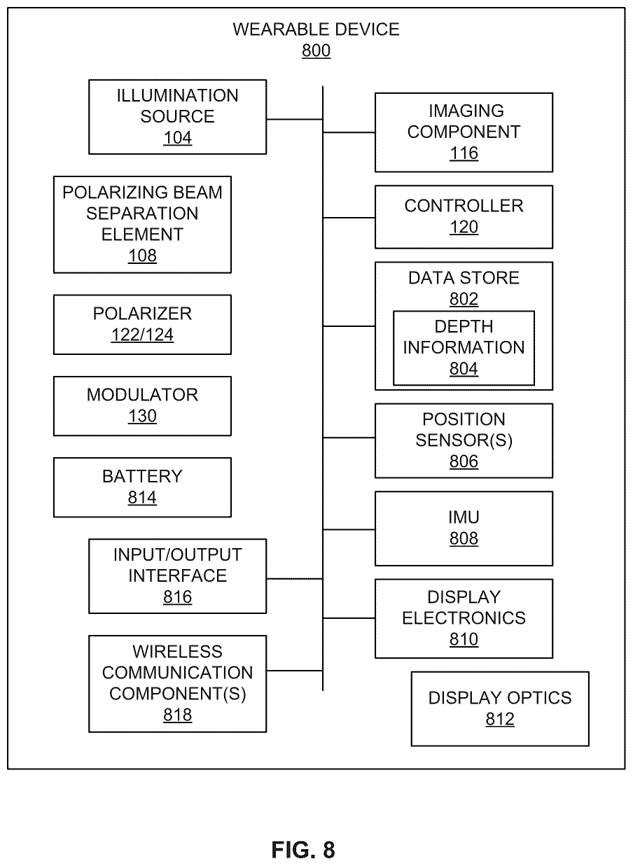

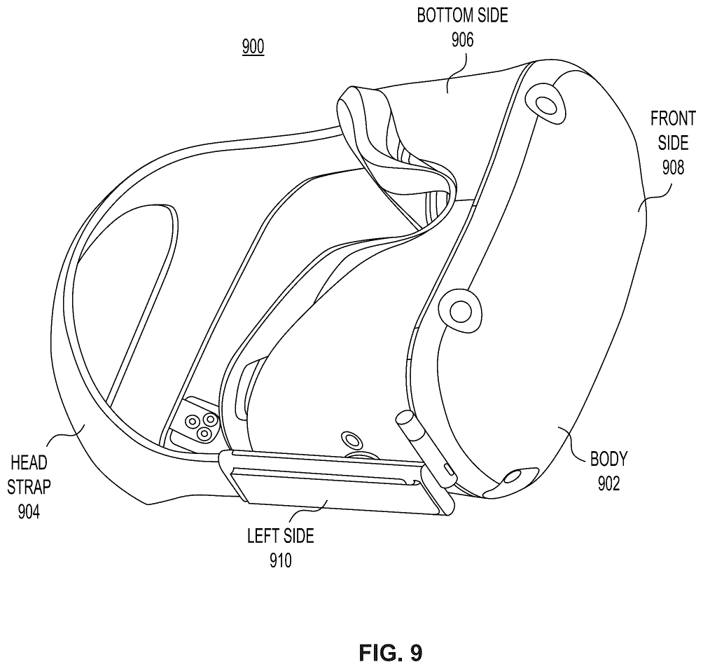

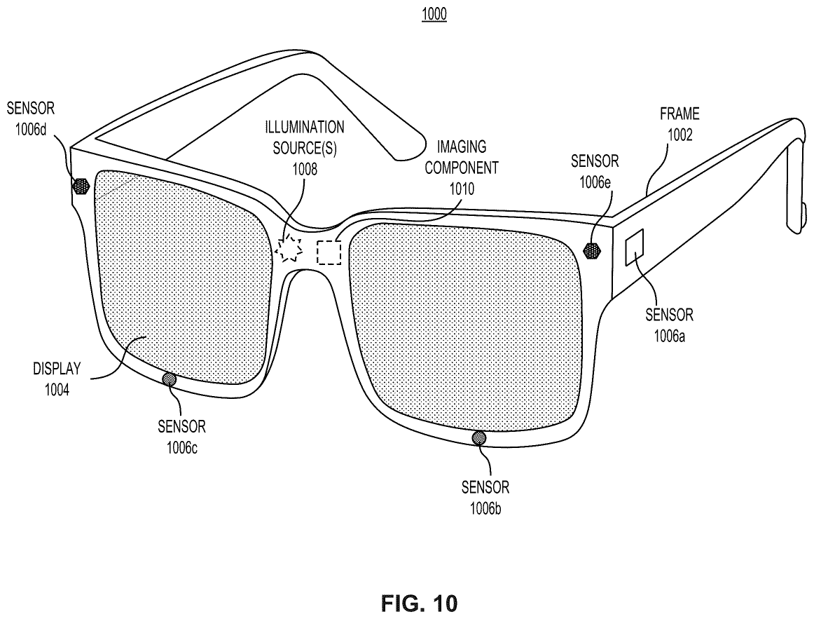

Turning now to FIG. 8, there is illustrated a block diagram of a wearable device 800 having components of a depth sensing apparatus 100, according to an example. The wearable device 800 may be a wearable eyewear, a wearable headset, smart glasses, a head-mountable device, eyeglasses, or the like. Examples of wearable devices 800 are depicted in FIGS. 9 and 10 and are described in greater detail herein below. In FIG. 8, the wearable device 800 is depicted as including components of the depth sensing apparatuses 100 disclosed herein. In this regard, the wearable device 800 is depicted as including an illumination source 104, a polarizing beam separation element 108, a polarizer 122, 124, an imaging component 116, and a controller 120. The polarizer 122, 124 may be a pixelated polarizer 200 as shown in FIG. 3 or a metasurface lens 220 as shown in FIG. 4. The wearable device 800 may optionally include the modulator 130 as discussed in the example depth sensing apparatuses 100 illustrated in FIGS. 5 and 6. The wearable device 800 may also optionally include multiple imaging components 116, 300, 302 and polarizers 124, 306, 308 as shown in FIG. 7.

As discussed herein, the controller 120 may control operations of various components of the wearable device 800. The controller 120 may be programmed with software and/or firmware that the controller 120 may execute to control operations of the components of the wearable device 800. For instance, the controller 120 may execute instructions to cause the illumination source 104 to output a light beam 106 and for the imaging component 116 to capture media, such as an image of the target area 102 and the interference pattern 110. As discussed herein, the target area 102 may include at least one eyebox, and may include portions of the face surrounding an eye within the eyebox, according to some examples. The target area 102 may also or alternatively include a local area of a user, for example, an area of a room the user is in.

As also discussed herein, the controller 120 may determine depth information 804 of the target area 102 using at least one image captured by the imaging component 116. The controller 120 may also determine tracking information from the depth information 804. The wearable device 800 may include a data store 802 into which the controller 120 may store the depth information 804, and in some examples, the tracking information. The data store 802 may be, for example, Read Only Memory (ROM), flash memory, solid state drive, Random Access memory (RAM), an Electrically Erasable Programmable Read-Only Memory (EEPROM), a storage device, or the like. In some examples, the data store 802 may have stored thereon instructions (not shown) that the controller 120 may execute as discussed herein.

In some examples, the wearable device 800 may include one or more position sensors 806 that may generate one or more measurement signals in response to motion of the wearable device 800. Examples of the one or more position sensors 806 may include any number of accelerometers, gyroscopes, magnetometers, and/or other motion-detecting or error-correcting sensors, or any combination thereof. In some examples, the wearable device 800 may include an inertial measurement unit (IMU) 808, which may be an electronic device that generates fast calibration data based on measurement signals received from the one or more position sensors 806. The one or more position sensors 806 may be located external to the IMU 808, internal to the IMU 808, or any combination thereof. Based on the one or more measurement signals from the one or more position sensors 806, the IMU 808 may generate fast calibration data indicating an estimated position of the wearable device 800 that may be relative to an initial position of the wearable device 800. For example, the IMU 808 may integrate measurement signals received from accelerometers over time to estimate a velocity vector and integrate the velocity vector over time to determine an estimated position of a reference point on the wearable device 800. Alternatively, the IMU 808 may provide the sampled measurement signals to a computing apparatus (not shown), which may determine the fast calibration data.

In some examples, the wearable device 800 is a “near-eye display”, which may refer to a device (e.g., an optical device) that may be in close proximity to a user's eyes. In these examples, the wearable device 800 may display images, e.g., artificial reality images, virtual reality images, and/or mixed reality images to a user's eyes. As used herein, “artificial reality” may refer to aspects of, among other things, a “metaverse” or an environment of real and virtual elements, and may include use of technologies associated with virtual reality (VR), augmented reality (AR), and/or mixed reality (MR). As used herein a “user” may refer to a user or wearer of a “near-eye display.”

In examples in which the wearable device 800 is a near-eye display, the wearable device 800 may include display electronics 810 and display optics 812. The display electronics 810 may display or facilitate the display of images to the user according to received data. For instance, the display electronics 810 may receive data from the imaging component 116 and may facilitate the display of images captured by the imaging component 116. The display electronics 810 may also or alternatively display images, such as graphical user interfaces, videos, still images, etc., from other sources. In some examples, the display electronics 810 may include one or more display panels. In some examples, the display electronics 810 may include any number of pixels to emit light of a predominant color such as red, green, blue, white, or yellow. In some examples, the display electronics 810 may display a three-dimensional (3D) image, e.g., using stereoscopic effects produced by two-dimensional panels, to create a subjective perception of image depth.

In some examples, the display optics 812 may display image content optically (e.g., using optical waveguides and/or couplers) or magnify image light received from the display electronics 810, correct optical errors associated with the image light, and/or present the corrected image light to a user of the wearable device 800. In some examples, the display optics 812 may include a single optical element or any number of combinations of various optical elements as well as mechanical couplings to maintain relative spacing and orientation of the optical elements in the combination. In some examples, one or more optical elements in the display optics 812 may have an optical coating, such as an anti-reflective coating, a reflective coating, a filtering coating, and/or a combination of different optical coatings.

In some examples, the display optics 812 may also be designed to correct one or more types of optical errors, such as two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

In some examples, the controller 120 may execute instructions to cause the display electronics 810 to display content on the display optics 812. By way of example, the displayed images may be used to provide a user of the wearable device 800 with an augmented reality experience such as by being able to view images of the user's surrounding environment along with other displayed images. In some examples, the controller 120 may use the determined tracking information in the display of the images, e.g., the positioning of the images displayed, the depths at which the images are displayed, etc.

In some examples, the display electronics 810 may use the orientation of the user's eye to introduce depth cues (e.g., blur image outside of the user's main line of sight), collect heuristics on the user interaction in the virtual reality (VR) media (e.g., time spent on any particular subject, object, or frame as a function of exposed stimuli), some other functions that are based in part on the orientation of at least one of the user's eyes, or any combination thereof. In some examples, because the orientation may be determined for both eyes of the user, the controller 120 may be able to determine where the user is looking or predict any user patterns, etc.

FIG. 8 further shows the wearable device 800 as including a battery 814, e.g., a rechargeable battery. When the wearable device 800 is not connected to an external power source, the battery 814 provides power to the components in the wearable device 800. In order to reduce or minimize the size and weight of the wearable device 800, the battery 814 may have a relatively small form factor.

The wearable device 800 is also depicted as including an input/output interface 816 through which the wearable device 800 may receive input signals and may output signals. The input/output interface 816 may interface with one or more control elements, such as power buttons, volume buttons, a control button, a microphone, the imaging component 116, and other elements through which a user may perform input actions on the wearable device 800. A user of the wearable device 800 may thus control various actions on the wearable device 800 through interaction with the one or more control elements, through input of voice commands, through use of hand gestures within a field of view of the imaging component 116, through activation of a control button, etc.

The input/output interface 816 may also or alternatively interface with an external input/output element (not shown). The external input/output element may be a controller with multiple input buttons, a keyboard, a mouse, a game controller, a glove, a button, a touch screen, or any other suitable device for receiving action requests from users and communicating the received action requests to the wearable device 800. A user of the wearable device 800 may control various actions on the wearable device 800 through interaction with the external input/output element, which may include physical inputs and/or voice command inputs. The controller 120 may also output signals to the external input/output element to cause the external input/output element to provide feedback to the user. The signals may cause the external input/output element to provide a tactile feedback, such as by vibrating, to provide an audible feedback, to provide a visual feedback on a screen of the external input/output element, etc.

The wearable device 800 may also include at least one wireless communication component 818. The wireless communication component(s) 818 may include one or more antennas and any other components and/or software to enable wireless transmission and receipt of radio waves. For instance, the wireless communication component(s) 818 may include an antenna through which wireless fidelity (WiFi) signals may be transmitted and received. As another example, the wireless communication component(s) 818 may include an antenna through which Bluetooth™ signals may be transmitted and received. As a yet further example, the wireless communication component(s) 818 may include an antenna through which cellular signals may be transmitted and received. In some examples, the wireless communication component(s) 818 may transmit and receive data through multiple ranges of wavelengths and thus, may transmit and receive data across multiple ones of WiFi, Bluetooth™, cellular, ultra-wideband (UWB), etc., radio wavelengths.

According to examples, the wearable device 800 may be coupled to a computing apparatus (not shown), which is external to the wearable device 800. For instance, the wearable device 800 may be coupled to the computing apparatus through a Bluetooth™ connection, a wired connection, a WiFi connection, or the like. The computing apparatus may be a companion console to the wearable device 800 in that, for instance, the wearable device 800 may offload some operations to the computing apparatus. In other words, the computing apparatus may perform various operations that the wearable device 800 may be unable to perform or that the wearable device 800 may be able to perform, but are performed by the computing apparatus to reduce or minimize the load on the wearable device 800.

FIG. 9 illustrates a perspective view of a wearable device 900, such as a near-eye display device, and particularly, a head-mountable display (HMD) device, according to an example. The HMD device 900 may include some or all of the features of the wearable device 800 discussed herein with respect to FIG. 8. In some examples, the HMD device 900 may be a part of a virtual reality (VR) system, an augmented reality (AR) system, a mixed reality (MR) system, another system that uses displays or wearables, or any combination thereof. In some examples, the HMD device 900 may include a body 902 and a head strap 904. FIG. 9 shows a bottom side 906, a front side 908, and a left side 910 of the body 902 in the perspective view. In some examples, the head strap 904 may have an adjustable or extendible length. In particular, in some examples, there may be a sufficient space between the body 902 and the head strap 904 of the HMD device 900 for allowing a user to mount the HMD device 900 onto the user's head. In some examples, the HMD device 900 may include additional, fewer, and/or different components. For instance, the HMD device 900 may include the components of the depth sensing apparatus 100 as discussed herein.

In some examples, the HMD device 900 may present, to a user, media or other digital content including virtual and/or augmented views of a physical, real-world environment with computer-generated elements. Examples of the media or digital content presented by the HMD device 900 may include images (e.g., two-dimensional (2D) or three-dimensional (3D) images), videos (e.g., 2D or 3D videos), audio, or any combination thereof. In some examples, the images and videos may be presented to each eye of a user by one or more display assemblies (not shown in FIG. 9) enclosed in the body 902 of the HMD device 900.

In some examples, the HMD device 900 may include various sensors (not shown), such as depth sensors, motion sensors, position sensors, and/or eye tracking sensors. Some of these sensors may use any number of structured or unstructured light patterns for sensing purposes as discussed herein. In some examples, the HMD device 900 may include a virtual reality engine (not shown), that may execute applications within the HMD device 900 and receive depth information, position information, acceleration information, velocity information, predicted future positions, or any combination thereof of the HMD device 900 from the various sensors.

In some examples, the information received by the virtual reality engine may be used for producing a signal (e.g., display instructions) to the one or more display electronics 810. In some examples, the HMD device 900 may include locators (not shown), which may be located in fixed positions on the body 902 of the HMD device 900 relative to one another and relative to a reference point. Each of the locators may emit light that is detectable by an external camera. This may be useful for the purposes of head tracking or other movement/orientation. It should be appreciated that other elements or components may also be used in addition or in lieu of such locators.

It should be appreciated that in some examples, a projector mounted in a display system may be placed near and/or closer to a user's eye (i.e., “eye-side”). In some examples, and as discussed herein, a projector for a display system shaped liked eyeglasses may be mounted or positioned in a temple arm (i.e., a top far corner of a lens side) of the eyeglasses. It should be appreciated that, in some instances, utilizing a back-mounted projector placement may help to reduce size or bulkiness of any required housing required for a display system, which may also result in a significant improvement in user experience for a user.

FIG. 10 illustrates a perspective view of a wearable device 1000, such as a near-eye display, in the form of a pair of smartglasses, glasses, or other similar eyewear, according to an example. In some examples, the wearable device 1000 may be a specific implementation of the wearable device 800 of FIG. 8, and may be configured to operate as a virtual reality display, an augmented reality display, and/or a mixed reality display. In some examples, the wearable device 1000 may be eyewear, in which a user of the wearable device 1000 may see through lenses in the wearable device 1000.

In some examples, the wearable device 1000 includes a frame 1002 and a display 1004. In some examples, the display 1004 may be configured to present media or other content to a user. In some examples, the display 1004 may include display electronics 810 and/or display optics 812, similar to the components described with respect to FIG. 8. For example, the display 1004 may include a liquid crystal display (LCD) display panel, a light-emitting diode (LED) display panel, or an optical display panel (e.g., a waveguide display assembly). In some examples, the display 1004 may also include any number of optical components, such as waveguides, gratings, lenses, mirrors, etc. In other examples, the display 1004 may be omitted and instead, the wearable device 1000 may include lenses that are transparent and/or tinted, such as sunglasses.

In some examples, the wearable device 1000 may further include various sensors 1006a, 1006b, 1006c, 1006d, and 1006e on or within the frame 1002. In some examples, the various sensors 1006a-1006e may include any number of depth sensors, motion sensors, position sensors, inertial sensors, and/or ambient light sensors, as shown. In some examples, the various sensors 1006a-1006e may include any number of image sensors configured to generate image data representing different fields of views in one or more different directions. In some examples, the various sensors 1006a-1006e may be used as input devices to control or influence the displayed content of the wearable device 1000, and/or to provide an interactive virtual reality (VR), augmented reality (AR), and/or mixed reality (MR) experience to a user of the wearable device 1000. In some examples, the various sensors 1006a-1006e may also be used for stereoscopic imaging or other similar application.

In some examples, the wearable device 1000 may further include one or more illumination sources 1008 to project light into a physical environment. The projected light may be associated with different frequency bands (e.g., visible light, infra-red light, ultra-violet light, etc.), and may serve various purposes. The wearable device 1000 may also include the polarizing beam separation element 108 and polarizer 122, 124 through which light emitted from the illumination source(s) 1008 may propagate as discussed herein. The illumination source(s) 1008 may be equivalent to the illumination source 104 discussed herein.

In some examples, the wearable device 1000 may also include an imaging component 1010. The imaging component 1010, which may be equivalent to the imaging component 116, for instance, may capture images of the physical environment in the field of view such as the target area 102 and the interference pattern 110. In some instances, the captured images may be processed, for example, by a virtual reality engine (not shown) to add virtual objects to the captured images or modify physical objects in the captured images, and the processed images may be displayed to the user by the display 1004 for augmented reality (AR) and/or mixed reality (MR) applications. The captured images may also be used to determine depth information as discussed herein.

The illumination source(s) 1008 and the imaging component 1010 may also or alternatively be directed to an eyebox as discussed herein and may be used to track a user's eye movements.

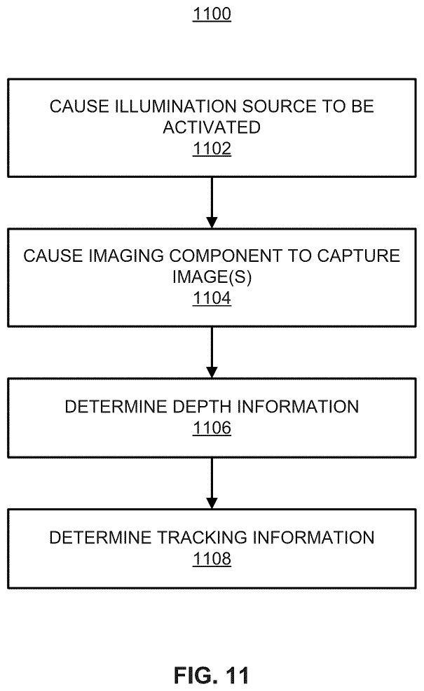

Various manners in which the controller 120 of the wearable device 800 may operate are discussed in greater detail with respect to the method 1100 depicted in FIG. 11. FIG. 11 illustrates a flow diagram of a method 1100 for determining depth information of a target area 102 using generated polarization interference patterns 110, according to an example. It should be understood that the method 1100 depicted in FIG. 11 may include additional operations and that some of the operations described therein may be removed and/or modified without departing from the scope of the method 1100. The description of the method 1100 are made with reference to the features depicted in FIG. 8 for purposes of illustration.

At block 1102, the controller 120 may cause an illumination source 104 to be activated. Activation of the illumination source 104 may cause a light beam 106 to be directed onto a polarizing beam separation element 108. As discussed herein, the polarizing beam separation element 108 may generate a right hand circularly polarized (RCP) beam 112 and a left hand circularly polarized (LCP) beam 114 to be projected onto a target area 102, in which the RCP beam 112 and the LCP beam 114 may create an interference with respect to each other. The interference may cause an interference pattern 110 to be created and projected onto the target area 102. In addition, a polarizer 122, 124 may increase the intensity of the interference pattern 110 either prior to the interference pattern 110 being projected onto the target area 102 or after the interference pattern 110 is reflected from the target area 102.

At block 1104, the controller 120 may cause an imaging component 116 (or multiple imaging components 116, 300, 302) to capture at least one image of the target area 102 and the interference pattern 110.

At block 1106, the controller 120 may determine depth information of the target area 102 using the captured image(s). The controller 120 may determine the depth information by, for instance, measuring distortion (e.g., via triangulation) of the interference pattern 110 over the target area 102.

At block 1108, the controller 120 may determine tracking information using the determined depth information. For instance, the controller 120 may track eye movements or movements of other objects using the determined depth information.

Some or all of the operations set forth in the method 1100 may be included as utilities, programs, or subprograms, in any desired computer accessible medium. In addition, the method 1100 may be embodied by computer programs, which may exist in a variety of forms both active and inactive. For example, they may exist as machine-readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

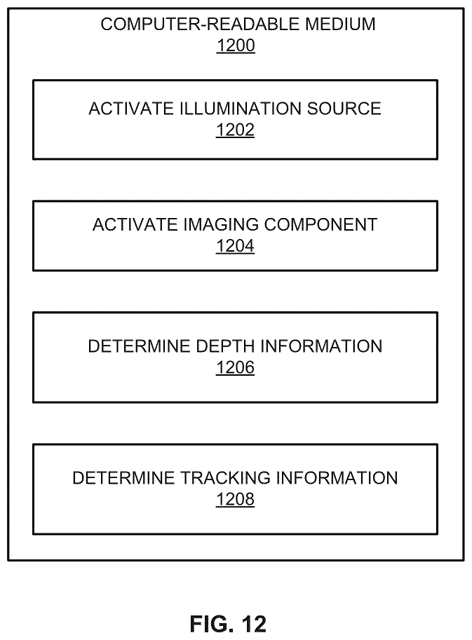

Turning now to FIG. 12, there is illustrated a block diagram of a computer-readable medium 1200 that has stored thereon computer-readable instructions for determining depth information of a target area 102 using generated polarization interference patterns, according to an example. It should be understood that the computer-readable medium 1200 depicted in FIG. 12 may include additional instructions and that some of the instructions described herein may be removed and/or modified without departing from the scope of the computer-readable medium 1200 disclosed herein. In some examples, the computer-readable medium 1200 is a non-transitory computer-readable medium, in which the term “non-transitory” does not encompass transitory propagating signals.

The computer-readable medium 1200 has stored thereon computer-readable instructions 1202-1208 that a controller, such as the controller 120 of the wearable device 800 depicted in FIG. 8 may execute. The computer-readable medium 1200 may be an electronic, magnetic, optical, or other physical storage device that contains or stores executable instructions. The computer-readable medium 1200 may be, for example, Random Access memory (RAM), an Electrically Erasable Programmable Read-Only Memory (EEPROM), a storage device, or an optical disc.

The controller may execute the instructions 1202 to activate an illumination source 104 in the wearable device 800. The controller may execute the instructions 1204 to activate at least one imaging component 116 to capture at least one image of the target area 102 and interference pattern 110. The controller may execute the instructions 1206 to determine depth information of the target area 102 from the at least one captured image. In addition, the controller may execute the instructions 1208 to determine tracking information of the target area 102.

In the foregoing description, various inventive examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. A depth sensing apparatus, comprising:
a polarizing beam separation element;
an illumination source to output a light beam onto the polarizing beam separation element, wherein the polarizing beam separation element is to generate a right hand circularly polarized (RCP) beam and a left hand circularly polarized (LCP) beam to be projected onto a target area, wherein an interference between the RCP beam and the LCP beam creates an interference pattern;
an imaging component to capture an image of the target area with the RCP beam and the LCP beam projected on the target area, wherein the captured image is to be analyzed for depth sensing of the target area; and
a polarizer positioned along a path of the light beam between the polarizing beam separation element and the imaging component, the polarizer to increase an intensity of the interference pattern.

2. The depth sensing apparatus of claim 1, further comprising:
a controller to determine depth information of the target area using the captured image.

3. The depth sensing apparatus of claim 1, wherein the polarizer is to increase the intensity of the interference pattern to be projected onto the target area.

4. The depth sensing apparatus of claim 1, wherein the polarizer is to increase the intensity of the interference pattern to be captured by the imaging component.

5. The depth sensing apparatus of claim 4, wherein the polarizer comprises a pixelated polarizer.

6. The depth sensing apparatus of claim 4, further comprising:
a second imaging component positioned to capture a second image of the target area; and
a second polarizer positioned to increase an intensity of a second interference pattern to be captured by the second imaging component, wherein the second interference pattern has a shifted period as compared to the interference pattern.

7. The depth sensing apparatus of claim 1, wherein the polarizer comprises a metasurface lens.

8. The depth sensing apparatus of claim 1, further comprising:
a modulator positioned between the polarizing beam separation element and the polarizer, wherein the modulator is to modulate the polarization of the RCP beam and the LCP beam to shift the interference pattern, and wherein the imaging component is to capture at least one image of the target area with the interference pattern shifted at one or more fractions of periods.

9. A depth sensing apparatus, comprising:
a polarizing beam separation element;
an illumination source to output a linearly polarized light beam onto the polarizing beam separation element, wherein the polarizing beam separation element is to generate a right hand circularly polarized (RCP) beam and a left hand circularly polarized (LCP) beam from the linearly polarized light beam, and wherein the RCP beam and the LCP beam form an interference pattern to be projected onto a target area;
an imaging component to capture at least one image of the target area and the interference pattern reflected from the target area;
a polarizer positioned to increase an intensity of the generated interference pattern captured by the imaging component; and
a controller to determine depth information of the target area using the at least one captured image.

10. The depth sensing apparatus of claim 9, wherein the polarizer is positioned adjacent to the polarizing beam separation element.

11. The depth sensing apparatus of claim 9, further comprising:
a modulator positioned between the polarizing beam separation element and the polarizer, wherein the modulator is to shift a period of the interference pattern.

12. The depth sensing apparatus of claim 9, wherein the polarizer is positioned adjacent to the imaging component.

13. The depth sensing apparatus of claim 12, wherein the polarizer comprises a pixelated polarizer.

14. The depth sensing apparatus of claim 12, further comprising:
a second imaging component positioned to capture a second image of the target area and the interference pattern reflected from the target area; and
a second polarizer positioned adjacent to the second imaging component to increase an intensity of the interference pattern captured by the second imaging component, wherein the interference pattern captured by the second imaging component has a period that is shifted with respect to the interference pattern captured by the imaging component.

15. The depth sensing apparatus of claim 12, wherein the polarizer comprises a metasurface lens.

16. A wearable device, comprising:
a polarizing beam separation element;
an illumination source to output a linearly polarized light beam onto the polarizing beam separation element, wherein the polarizing beam separation element is to form an interference pattern from the linearly polarized light beam to be projected onto a target area;
an imaging component to capture at least one image of the target area and the interference pattern reflected from the target area;
a polarizer positioned to increase an intensity of the generated interference pattern; and
a controller to determine depth information of the target area using the at least one captured image.

17. The wearable device of claim 16, further comprising:
a modulator positioned between the polarizing beam separation element and the polarizer, wherein the modulator is to modulate the polarization of the light beam to shift a period of the interference pattern, and wherein the imaging component is to capture at least image of the interference pattern at one or more shifted periods.

18. The wearable device of claim 16, wherein the polarizer comprises a pixelated polarizer.

19. The wearable device of claim 16, further comprising:
a second imaging component positioned to capture a second image of the target area and the interference pattern reflected from the target area; and
a second polarizer positioned adjacent to the second imaging component, wherein the second polarizer is to increase an intensity of the interference pattern captured by the second imaging component, and wherein the interference pattern captured by the second imaging component has a period that is shifted with respect to a period of the interference pattern captured by the imaging component.

20. The wearable device of claim 16, wherein the polarizer comprises a metasurface lens.
